(19) United States
(12) Patent Application Publication
(10) Pub. No.: US 2026/0311896 A1
(43) Pub. Date: Oct. 8, 2026

(54) COMPONENT FOR COMPRESSING MATTER

(71) Applicant: First Light Fusion Limited, Yarnton, Oxfordshire (GB)

(72) Inventors: Matthew Betney, Yarnton, Oxfordshire (GB); Mila Fitzgerald, Yarnton, Oxfordshire (GB); Jonathan Skidmore, Yarnton, Oxfordshire (GB); Nicholas Hawker, Yarnton, Oxfordshire (GB)

(21) Appl. No.: 19/482,935

(22) PCT Filed: May 16, 2024
(86) PCT No.: PCT/GB2024/051280

§ 371 Date: Nov. 10, 2025

(30) Foreign Application Priority Data
May 17, 2023 (GB) 2307365.3

(51) Int. Cl. G21B 3/00

(52) U.S. Cl. CPC G21B 3/008

(57) ABSTRACT

A component for compressing matter using an input shockwave. The component includes a volume defined within the component. The volume is configured to contain the matter to be compressed. The component also includes a focusing portion configured to manipulate the input shockwave to generate a localised concentration of energy at the volume. The focusing portion includes an input for inputting the input shockwave into the component and multiple layers. The layers include layers of a first material and layers of a second material that is different from the first material. One or more of the layers is an enclosing layer that surrounds the volumew.

### CROSS-REFERENCE TO RELATED APPLICATION(S)

This application is the U.S. national phase under 35 U.S.C. § 371 of International Application No. PCT/GB2024/051280 filed on May 16, 2024, and claims the benefit of United Kingdom Patent Application No. 2307365.3 filed on May 17, 2023, wherein the entire disclosures of the foregoing applications are hereby incorporated by reference herein.

### TECHNICAL FIELD

This invention relates to a component for compressing matter using an input shockwave, in particular to methods and apparatuses for compressing matter by producing high localised concentrations of energy by manipulating an input shockwave to produce a high pressure quasi-spherical shockwave incident on the matter to be compressed.

### BACKGROUND

It has been shown in WO 2011/138622 that an interaction between a shockwave in a non-gaseous medium and a gaseous medium can generate a high speed transverse jet of the non-gaseous medium that moves through the gaseous medium. This results in the jet impacting on and trapping a volume of the gaseous medium, which gives rise to an intense concentration of energy within the gas.

The present invention aims to provide alternative techniques for producing localised energy concentrations.

### SUMMARY

When viewed from a first aspect, the invention provides a component for compressing matter using an input shockwave, the component comprising:
a volume defined within the component, wherein the volume is configured to contain the matter to be compressed; and
a focusing portion configured to manipulate the input shockwave to generate a localised concentration of energy at the volume;
   wherein the focusing portion comprises:
      an input for inputting the input shockwave into the component; and
      a plurality of layers;
         wherein the plurality of layers comprises:
         one or more first layers comprising a first material; and
         one or more second layers comprising a second material that is different from the first material; and
         wherein one or more of the plurality of layers comprises an enclosing layer that surrounds the volume.

The invention thus provides a component that manipulates (e.g. focuses) an input shockwave to be incident upon a target volume within the component, when a shockwave is input into the component, causing localised concentration of energy to be generated at the target volume. The component includes a focusing portion that has multiple layers, including at least one enclosing layer that (e.g. completely) surrounds the target volume.

In use, the input shockwave propagates through the layers of the focusing portion from the input of the focusing portion to the target volume. The (e.g. shape and/or materials of the) layers are designed to manipulate (e.g. focus, e.g. modify the shape and/or intensity of) the shockwave as it passes through the (focusing portion of the) component towards the target volume.

Providing multiple layers may help to superimpose components of the shockwave that are reflected from the boundaries between the layers. Providing an enclosing layer may help to shape the shockwave for being incident upon (e.g. conforming to the shape of) the target volume.

The layers of the focusing portion may help to amplify the intensity of the input shockwave (and thus the concentration of the energy) between the input and the target volume, as the shockwave passes through the focusing portion.

In this way, a localised energy concentration (compared to the energy concentration of the input shockwave) is produced at the volume. As such, the shockwave at the target volume may have a greater (e.g. energy) intensity than the input shockwave and/or a different shape from the input shockwave.

The input of the focusing portion may be provided in any suitable and desired way, to input the shockwave into the (focusing portion of the) component. For example, nature of the input may depend on how the shockwave is generated.

In embodiments the input of the focusing portion comprises an input face or (e.g. outer) layer (e.g. the input layer having an input face). Preferably the input face or layer extends in one or more directions about (e.g. substantially perpendicular to) a central (longitudinal) axis of the (e.g. focusing portion of the) component. One or more (e.g. all) of the input face or layer, the focusing portion and the component may be (e.g. rotationally) symmetrical about the central axis.

In use, the (e.g. input face or layer of the) input may be arranged to be impacted, e.g. by a projectile, e.g. directed along the central axis so to be incident upon the input (face or layer). Thus, in some embodiments, the input shockwave may be generated in the component, for example, by the (e.g. input face or layer of the) input of the focusing portion being struck or impacted (e.g. by a projectile). In some embodiments, the input shockwave may be generated externally from the component, and, e.g., be received by (e.g. be incident upon) the input of the focusing portion.

In some embodiments, the (e.g. input face or layer of the) input comprises a concave portion (when the input is viewed externally). In embodiments, the (e.g. entire) input face or layer is concave and, e.g., continuously curved. Such embodiments may be used with a projectile (e.g. having a substantially flat impacting surface) that is arranged to strike the (e.g. input of the) component to generate a shockwave having a curved shock-front in the focusing portion.

In some embodiments, the (e.g. input face or layer of the) input comprises a convex portion (when the input is viewed externally). In embodiments, the (e.g. entire) input face or layer is convex. Such embodiments may be used with a projectile that is arranged to strike the (e.g. input of the) component to generate a shockwave. A convex input face may not help to curve the shockwave, but a convex input face may be less sensitive to projectile tilt (e.g. the projectile not being perfectly aligned with the input face) and so may be preferable to a concave face in systems where the angle of the projectile at the input is less predictable.

In some embodiments, the (e.g. input face or layer of the) input comprises a flat portion. In embodiments, the (e.g. entire) input face or layer is flat. Such embodiments may be used with a projectile having a curved (e.g. concave) impacting surface that is arranged to strike the (e.g. input of the) component to generate a shockwave having a curved shock-front in the focusing portion.

In embodiments, the (e.g. input face or layer of the) input has a convex face. Such embodiments may be configured to be used with a projectile having a corresponding concave impacting surface which is arranged to strike the (e.g. input of the) component such that the impacting surface of the projectile and the input face are aligned (e.g. the impacting surface is complementary to the input face) when the projectile impacts the component. Such embodiments may help to increase the energy coupling from the projectile into the component.

Although some examples have been described herein, all possible input face and projectile impacting face convex/concave combinations are envisaged.

One or more of the plurality of layers (the “first” layer(s)) is formed of (comprises or consists of) a first material. One or more of the plurality of layers (the “second” layer(s)) is formed of (comprises or consists of) a second material. The second material is different from the first material.

The first material may be different from the second material in any suitable and desired way. In some embodiments, the second material has a shock-impedance that is lower than a shock-impedance of the first material. Providing layers having different shock-impedances may cause the shockwave to be (at least partially) reflected from the boundaries between layers (e.g. at the boundaries between the first and second materials). This may help to superimpose components of the propagating shockwave within the focusing portion, e.g. to amplify the intensity of the shockwave that is incident upon the target volume.

The plurality of layers may be arranged in any suitable and desired way in the focusing portion of the component. Preferably the plurality of layers (e.g. one or more (e.g. all) of the first layers, the second layers and the enclosing layer are at least partially) between the input of the focusing portion and the target volume, e.g. such that the input shockwave passes through at least a portion of (at least some, e.g. each, of) the plurality of layers before it is incident upon the target volume.

The focusing portion may comprise any suitable and desired number of layers. In some embodiments the focusing portion comprises between two and twenty layers, e.g. between three and fifteen layers, e.g. between five and ten layers.

In some embodiments, one or more of the plurality of layers (each) extends in one or more directions about (e.g. substantially perpendicular to) a central (longitudinal) axis of the (e.g. focusing portion of the) component. In some embodiments, (e.g. each of) the plurality of layers is (e.g. rotationally) symmetrical about the central axis.

In some embodiments, one or more of the plurality of layers (each) has a lateral dimension (e.g. in direction(s) perpendicular to the central axis) that is (e.g. significantly) greater than a thickness of the respective layer (the thickness being the dimension of the layer in a direction perpendicular to the lateral dimension, e.g. the thickness being in the direction of the central axis). In some embodiments one or more of the plurality of layers (each) extends across the majority (e.g. all) of the lateral dimension of the focusing portion (e.g. in direction(s) perpendicular to the central axis). For example, one or more of the plurality of layers (each) extends between the edges of the focusing portion, i.e. across the whole of the focusing portion.

It will be appreciated that when the focusing portion comprises one or more layers that extend across the majority (e.g. all) of the lateral dimension (e.g. between the edges) of the focusing portion, the focusing portion comprises these layer(s) in addition to the one or more enclosing layers that surround the target volume. Thus, in some embodiments, one or more of the plurality of layers (e.g. that extend between the edges of the focusing portion) (each) does not surround the target volume.

The focusing portion may comprise any suitable and desired number of layers that extend across the majority (e.g. all) of the lateral dimension of the focusing portion. In some embodiments the focusing portion comprises between two and ten layers, e.g. between three and eight layers, e.g. between four and six layers, that extend across the majority (e.g. all) of the lateral dimension.

In some embodiments, the plurality of layers may (each) be defined (at least) by an input face (the outer surface of the layer that is arranged to substantially receive the shockwave propagating through the focusing portion as an input to the layer) and an output face (the outer surface of the layer that is arranged to substantially output the shockwave propagating through the focusing portion from the layer).

In embodiments, the input face and/or the output face of (each of) one or more of the plurality of layers comprises a (e.g. continuously) curved portion. The curved portion at the input and/or output face(s) of the layer(s) may help to focus the shockwave, at least partially spherically, on the target volume.

In embodiments, the plurality of layers comprises one or more layers (each) having an input face comprising a convex portion. (It will be understood that the input face is convex when viewed externally, as the outer surface of the layer.) In embodiments, the (e.g. entire) input face (of one or more of the plurality of layers) is convex. A layer having an input face comprising a convex portion may help to (e.g. spherically) focus the input shockwave.

The convex portion may be (e.g. continuously) curved or the convex portion may comprise a plurality of flat portions that together form a convex surface.

In embodiments, two or more of the plurality of layers have an input face comprising a convex portion, wherein the radius of curvature of the convex portion(s) of layer(s) distal from the target volume (e.g. proximal to the input of the focusing portion) are greater than the radius of curvature of the convex portion(s) of layer(s) proximal to the target volume (e.g.

distal from the input). Thus, preferably, the radius of curvature of the convex portions decreases (e.g. progressively) from the input of the focusing portion towards the target volume.

In embodiments, the plurality of layers comprises one or more layers (each) having an output face comprising a concave portion. (It will be understood that the output face is concave when viewed externally, as the outer surface of the layer.) In embodiments, the (e.g. entire) output face (of one or more of the plurality of layers) is concave. A layer having an output face comprising a concave portion may help to (e.g. spherically) focus the input shockwave.

The concave portion may be (e.g. continuously) curved or the concave portion may comprise a plurality of flat portions that together form a concave surface.

In embodiments, two or more of the plurality of layers have an output face comprising a concave portion, wherein the radius of curvature of the concave portion(s) of layer(s) distal from the target volume (e.g. proximal to the input of the focusing portion) are greater than the radius of curvature of the concave portion(s) of layer(s) proximal to the target volume (e.g. distal from the input). Thus, preferably, the radius of curvature of the concave portions decreases (e.g. progressively) from the input of the focusing portion towards the target volume.

In embodiments, the plurality of layers comprises one or more layers (each) having a non-uniform (e.g. variable) thickness. The thickness may be defined as the dimension of the layer that is in a direction perpendicular to the lateral dimension of the layer. The thickness may be defined as the dimension of the layer that is in a direction perpendicular to the input face and/or output face of the layer. The thickness may be defined as the dimension of the layer that is the minimum distance from the input face to the output face at any given point on a layer.

Thus, the thickness of one or more of the layers may be different in different parts of the layer. When a shockwave is incident upon a layer having non-uniform thickness, the duration that different portions of the shock-front spend propagating through the layer may differ.

Thus, a layer having a non-uniform thickness may alter the shape of the shock-front, e.g. to focus the shockwave towards the target volume.

The thickness of the non-uniform layer(s) may vary across the layer in any suitable and desired way. In some embodiments, the thickness of one or more of the plurality of layers is greater proximal to a central (longitudinal) axis of the (e.g. focusing portion of the) component than proximal to the edge(s) of the respective layer.

By providing one or more layers (each) having a greater thickness proximal to the central axis of the component than the thickness proximal to the edge of the component, when a shockwave is incident upon the layer, the central portion of the shock-front spends longer propagating through the (centre of the) layer than the portions of the shock-front proximal to the edge(s) of the layer. This may help to (e.g. spherically) focus the shockwave. In embodiments, at least one (e.g. all) of the one or more first layers may have a thickness that tapers (e.g. to zero) at or close to the edge of the component such that the first layer does not extend all the way to the edge of the component.

In embodiments in which the plurality of layers comprises at least one first layer and at least one second layer, preferably one or more (e.g. all) of the at least one second layer (e.g. each) has a maximum thickness that is greater than the maximum thickness of (e.g. each of) one or more (e.g. all) of the at least one first layer.

In embodiments in which the plurality of layers comprises a plurality of first layers and/or a plurality of second layers, each of the plurality of first layers may have the same maximum thickness and/or each of the plurality of second layers may have the same maximum thickness, preferably with the plurality of second layers (e.g. each) having a maximum thickness greater than the maximum thickness of (e.g. each of) the plurality of first layers.

In embodiments, the maximum thicknesses of the plurality of first layers varies between the first layers. In embodiments, the maximum thicknesses of the plurality of second layers varies between the second layers.

In embodiments, the maximum thicknesses of the plurality of first layers decrease (e.g. progressively) from the input to the volume configured to contain the matter to be compressed. In embodiments, the maximum thicknesses of the plurality of second layers decrease (e.g. progressively) from the input to the volume configured to contain the matter to be compressed.

In embodiments, the average thicknesses (e.g. the average thickness of each layer across its width) of the plurality of first layers decrease (e.g. progressively) from the input to the volume configured to contain the matter to be compressed. In embodiments, the average thicknesses (e.g. the average thickness of each layer across its width) of the plurality of second layers decrease (e.g. progressively) from the input to the volume configured to contain the matter to be compressed.

The first and second layers may be arranged in any suitable and desired way in the focusing portion. In some embodiments, the one or more first layers and the one or more second layers are arranged to alternate between a first layer and a second layer (e.g. repeatedly when there are a plurality of first and/or second layers). Thus, preferably (each of one or more of) the first layer(s) is adjacent (sandwiched between) two second layers and/or (each of one or more of) the second layer(s) adjacent (sandwiched between) two first layers.

In embodiments where the first material has a different (e.g. greater) shock-impedance than the second material, the differences in the shock-impedance of the layers may be used with the shape of the layers to manipulate (e.g. focus) the shockwave as it propagates through the focusing portion.

For example, when the first material has a greater shock-impedance than the second material, the incident shockwave will travel slower in the first layers than in the second layers. Furthermore, when the first layer has a greater thickness at its centre than at its edges, the portion of the shock-front at or close to the edge travels slowly for a shorter period of time than the central portion of the shock-front. This may help to (e.g. spherically) focus the shockwave, e.g. towards the target volume.

The focusing portion comprises one or more enclosing layers surrounding the target volume. The enclosing layer(s) may be arranged in any suitable and desired position in the focusing portion, e.g. relative to the target volume, the input and/or the other of the plurality of layers.

Generally, the enclosing layer(s) are arranged between the input of the focusing portion and the target volume.

When the focusing portion comprises one or more layers that extend across the majority (e.g. all) of the lateral dimension of the focusing portion, preferably the enclosing layer(s) are arranged between these layers and the target volume, e.g. the enclosing layer(s) are proximal to the target volume and the one or more layers that extend across the majority (e.g. all) of the lateral dimension of the focusing portion are proximal to the input of the focusing portion.

In such arrangements, the one or more layers that extend across the majority (e.g. all) of the lateral dimension of the focusing portion may act to shape the input shockwave when it is first input into the focusing portion, e.g. to (e.g. spherically) focus the shockwave, such that it is shaped to at least partially conform to the shape of the enclosing layer(s). The enclosing layer(s) may then further shape (e.g. spherically focus) the shockwave to at least partially conform to the shape of the target volume.

The focusing portion may comprise any suitable and desired number of enclosing layers. In some embodiments, the focusing portion comprises between two and six enclosing layers, e.g. between three and five enclosing layers.

When the focusing portion comprises a plurality of enclosing layers, preferably each of the enclosing layers surrounds the target volume. Thus, preferably the enclosing layers are arranged concentrically around the target volume.

The enclosing layer(s) may have any suitable and desired size and shape. In some embodiments the enclosing layer(s) (each) have a thickness that is significantly less than a maximum dimension (e.g. major axis or diameter) of the enclosing layer(s).

In some embodiments, one or more of the enclosing layer(s) is spherical, e.g. comprises a spherical annulus (shell). Spherical enclosing layer(s) may help to (at least partially) (e.g. spherically) focus the shockwave towards the target volume.

In some embodiments, one or more of the enclosing layer(s) is ovoidal (egg-shaped), e.g. comprises an ovoidal annulus (shell). Ovoidal enclosing layer(s) may help to (at least partially) (e.g. spherically) focus the shockwave towards the target volume.

In these embodiments, the enclosing layer(s) may be arranged such that the longest dimension (major axis) of the ovoid is parallel (e.g. coaxial) with the central axis of the (e.g. focusing portion of the) component. In this configuration, the central portion of the shock-front of the shockwave that is incident upon the enclosing layer(s) may have a larger amount of material to travel through to reach the target volume than the portions of the shock-front at the sides and below the enclosing layer. This may help to (e.g. spherically) focus the shock-front towards the target volume.

The target volume may be located at any suitable and desired position relative to the enclosing layer(s). For example, the target volume may be at the centre of the enclosing layer(s). In some embodiments the target volume is located (e.g. centred) on the central axis of the (e.g. focusing portion of the) component.

In some embodiments, the target volume is off-centre relative to the (e.g. innermost) enclosing layer(s), e.g. the centre of the target volume is offset from the centre of the volume defined (enclosed) by the (e.g. innermost) enclosing layer(s). This may help to amplify the effect of the focusing of the shockwave, e.g. when the enclosing layer(s) are ovoid.

The volume for containing the matter to be compressed (the “target volume”) may be provided in any suitable and desired way. In some embodiments, the volume is defined by (e.g. the inner face of) the (e.g. innermost) enclosing layer(s). In some embodiments, the volume comprises a casing for containing the matter to be compressed. Preferably the casing is housed within the (e.g. innermost) enclosing layer(s).

The (e.g. casing of the) target volume may be any suitable and desired shape. In some embodiments, the target volume has a circular cross-section, e.g. in a plane parallel to (e.g. containing) the central axis of the component. In some embodiments the target volume is substantially spherical.

In some embodiments, the component comprises a body comprising a (e.g. curved) recess, wherein the target volume and focusing portion are located at least partially within the recess. Preferably the body comprises one or more (e.g. curved) recess walls that define the recess.

The body may be provided in any suitable and desired way. In some embodiments, the body comprises (e.g. is formed from, e.g. consists of) a third material. Preferably the third material has a higher shock-impedance than the second material. Forming the body from the third material helps to at least partially) reflect portions of the shockwave from the recess walls (e.g. at the boundary between the third material and the first or second material) that may otherwise propagate into the body.

In some embodiments, the third material has the same shock-impedance as the first material. In some embodiments, the third material is the same as the first material.

Preferably the body is a unitary body, e.g. formed from the third material. Thus, preferably the body is formed as a single part.

In some embodiments the layer at the input of the focusing portion (e.g. the input layer) is a vacuum. In embodiments, the input layer may not be a vacuum, and may instead contain a gas.

When the input layer is a vacuum, and the component is struck with a projectile, at first, the projectile only strikes the body of the component directly. This leads to the generation of an axially converging shock reflection within the projectile, that passes into the focusing portion when the front face of the projectile contacts the first non-vacuum filled layer of the focusing portion. These transmitted-reflected shocks may subsequently superimpose on the central axis within the focusing portion leading to the generation of a high pressure state that expands as a Mach stem. In such embodiments, it is preferable that the projectile is smaller than an input of the recess such that the edges of the projectile first strike the recess wall.

In some embodiments the component comprises at least one impedance matching layer adjacent to or at the input of the focusing portion. In some embodiments, the input (e.g. layer) of the focusing portion comprises the impedance matching layer.

Providing an impedance matching layer, e.g. matching the impedance of an incident projectile, may help to couple the incident shockwave into the (e.g. focusing portion of the) component. Thus, as outlined above in relation to the input of the focusing portion, the impedance matching layer may be arranged to be impacted by a projectile to generate the input shockwave.

Thus, in some embodiments, the input of the focusing portion is provided by (e.g. an outer surface of) the impedance matching layer, e.g. together with an outer surface of the body (where provided). In some embodiments, the impedance matching layer extends across the (e.g. input of the) focusing portion, e.g. between the wall(s) of the body (e.g. that form the recess). Thus, the body and/or the impedance matching layer may comprise (e.g. together form) an input face. An outer surface of the body and outer surface of the impedance matching layer may be co-planar.

In some embodiments, the (e.g. plurality of layers of the) focusing portion is spaced from the body of the component, e.g. from the wall(s) of the recess. In embodiments, the recess comprises a gap between the (e.g. plurality of layers of the) focusing portion and the body of the component. Thus, in some embodiments, all of the plurality of layers are spaced from the body of the component.

The gap may be filled with (e.g. comprise or consist of) a vacuum. In embodiments, the gap comprises a buffer layer (e.g. comprising (e.g. consisting of) a fourth material) adjacent the walls of the cavity. Thus the (walls of the) recess may be lined with the buffer layer. In in embodiments, the component comprises a buffer between the (e.g. plurality of layers of the) focusing portion and the body (e.g. the recess walls).

The gap and/or the buffer layer may help to reflect shockwaves from the recess wall, reducing coupling of the shockwave into the body of the component and, e.g., instead focusing the shockwave towards the target volume.

The first material may comprise or consist of any suitable and desired material. Preferably the first material is a solid. Preferably the first material comprises (e.g. is formed from, e.g. consists of) a high shock-impedance material. Preferably the first material comprises (e.g. is formed from, e.g. consists of) a metal, e.g. a refractory metal, e.g. tantalum. The first material may comprise (e.g. be formed from, e.g. consists of) tungsten, steel, copper or other (e.g. heavy) metals. Such materials are resistant to high temperatures and pressures, have a high shock-impedance and hardness.

The second material may comprise or consist of any suitable and desired material. In some embodiments the second material comprises (e.g. is formed from, e.g. consists of) a polymer (e.g. polymethyl methacrylate (PMMA)), epoxy resin or low density foams.

The third material may comprise or consist of any suitable and desired material. Preferably the third material is a solid. Preferably the third material comprises (e.g. is formed from, e.g. consists of) a high shock-impedance material. Preferably the third material comprises (e.g. is formed from, e.g. consists of) a metal, e.g. a refractory metal, e.g. tantalum. The third material may comprise (e.g. be formed from, e.g. consists of) tungsten, steel, copper or other (e.g. heavy) metals.

The buffer layer may be formed of the same material as the second layers (e.g. the fourth material may be the same material as the second material). In embodiments, the buffer layer is formed from (e.g. comprises or consists of) a low density material such as PMMA or epoxy resin.

In embodiments, the matter to be compressed comprises a fuel, e.g. a fusionable fuel (e.g. hydrogen, deuterium and/or tritium) such that the target volume is a fuel volume and the component is a component for compressing fuel. When fuel is present in the volume and an input shockwave is manipulated by the focusing portion to produce a localised energy concentration at the volume, this may cause the fuel in the volume to collapse, creating high pressures and temperatures within the fuel, e.g. sufficient for initiating fusion.

In embodiments, the matter to be compressed may comprise a fuel-containing material. It will be understood that the term “fuel-containing material” refers to a material that is not solely fuel. Rather, a fuel-containing material comprises a material (e.g. a bulk or lattice material) that is not fuel, in or among which fuel is contained (e.g. as part of a mixture or compound). In embodiments, the fuel-containing material comprises fuel that is (e.g. uniformly) dispersed throughout the material. In embodiments, the fuel-containing material comprises a non-localised fuel.

In some embodiments, the fuel-containing material is a compound, e.g. with the fuel ionically or covalently bonded in the compound. Thus, in some embodiments, the fuel-containing material comprises a hydride such as water, lithium hydride, aluminium hydride or ammonia. In some embodiments, the fuel-containing material comprises a deuteride such as deuterated water, lithium deuteride, aluminium deuteride or deuterated ammonia. In some embodiments, the fuel-containing material comprises a tritiide such as tritiated water, lithium tritiide, aluminium tritiide or tritiated ammonia.

In some embodiments, the fuel-containing material comprises a hydrocarbon (e.g. deuterated or tritiated hydrocarbon). It will be understood that in a (e.g. deuterated or tritiated) hydrocarbon (or other hydrogen, deuterium or tritium containing compound), the fuel is provided by the hydrogen, deuterium or tritium atoms or ions in the compound and the remaining atoms or ions are the bulk material.

In some embodiments, the fuel-containing material is a fuel-doped material, e.g. a material into which the fuel (e.g. fuel atoms or ions) replaces atoms or ions, for example, in the material, e.g. in a (e.g. crystalline) lattice. In some embodiments, the fuel-containing material comprises fuel-doped metal, such as hydrogen-doped palladium, hydrogen-doped aluminium, hydrogen-doped lithium, deuterium-doped palladium, deuterium-doped aluminium, deuterium-doped lithium, tritium-doped palladium, tritium-doped aluminium or tritium-doped lithium.

It will be understood that in a fuel-doped material, the fuel is provided by the dopant (e.g. the hydrogen, deuterium or tritium atoms or ions that are inserted into the material) and the remaining atoms or ions are the bulk (or lattice) material.

In some embodiments, the fuel-containing material is a mixture containing the fuel, e.g. the fuel may be located in interstitial gaps in the (e.g. bulk or lattice) material, such that the fuel-containing mixture is a mixture of the (e.g. bulk or lattice) material and the fuel.

In some embodiments, the fuel-containing material comprises a non-gaseous material, e.g. a liquid. In some embodiments, the fuel-containing material comprises a non-fluid material, such that it substantially holds its own shape (at normal temperatures and pressures). In some embodiments, the fuel-containing material comprises a semi-solid (e.g. a gel or foam) fuel-containing material. In some embodiments, the fuel-containing material comprises a solid fuel-containing material. In some embodiments the fuel-containing material comprises a fuel-containing metal, e.g. fuel-containing palladium, aluminium or lithium.

The fuel may comprise any suitable and desired fuel. In some embodiments, the fuel comprises a fusionable fuel, e.g. hydrogen, deuterium and/or tritium. Thus, in some embodiments, the component is configured to manipulate the input shockwave to provide a localised concentration of energy within the target element that is suitable for initiating fusion, e.g. to generate a localised concentration of energy of sufficiently high temperature and/or pressure.

The invention also provides a method of compressing matter using an input shockwave and thus, from a further aspect, the invention provides a method of compressing matter using an input shockwave, the method comprising generating the input shockwave at the input of the focusing portion of the component according to any one of the aspects or embodiments described herein.

It will be appreciated that this aspect may (and preferably does) include one or more (e.g. all) of the preferred and optional features disclosed herein, e.g. relating to other aspects and embodiments of the invention, as applicable.

In embodiments, the matter to be compressed comprises a fuel, e.g. a fusionable fuel (e.g. hydrogen, deuterium and/or tritium) or a fuel-containing material, such that the method is a method of compressing fuel or a fuel-containing material.

For example, the method may comprise generating the input shockwave in the component, for example, by striking or impacting the (e.g. input face or layer of the) input of the focusing portion (e.g. by a projectile). In some embodiments, the input shockwave may be generated externally from the component, and, e.g., be received by (e.g. be incident upon) the input of the focusing portion. Thus, the method may comprise generating an external shockwave and causing the shockwave to be incident upon (e.g. directing the shockwave towards) the input of the focusing portion.

Preferably the shockwave is arranged (allowed) to (at least initially) propagate along a direction parallel to the central (longitudinal) axis of the component. Thus, preferably the shockwave is arranged to be incident upon or is generated in the input of the component in a plane perpendicular to the central (longitudinal) axis of the component, e.g. parallel to a plane of the input of the focusing portion.

The invention also provides a system for compressing matter using an input shockwave and thus, from a further aspect, the invention provides a system for compressing matter using an input shockwave, the system comprising:
a component according to any one of the aspects or embodiments described herein; and
a mechanism for generating the input shockwave at the input of the focusing portion of the component.

It will be appreciated that this aspect may (and preferably does) include one or more (e.g. all) of the preferred and optional features disclosed herein, e.g. relating to other aspects and embodiments of the invention, as applicable.

In embodiments, the matter to be compressed comprises a fuel, e.g. a fusionable fuel (e.g. hydrogen, deuterium and/or tritium) or a fuel-containing material, such that the system is a system for compressing fuel or a fuel-containing material. In some embodiments, the fuel within the fuel-containing material comprises a mixture of deuterium and tritium.

In some embodiments, the mechanism comprises:
a driving mechanism configured to drive a projectile into the component to generate a shockwave at the (e.g. input face or layer of the) input of the focusing portion of the component.

The projectile preferably comprises an impacting surface arranged to impact the (e.g. input of the) focusing portion of the component.

In some embodiments, the impacting surface of the projectile comprises a substantially flat (e.g. planar) portion. Such projectiles may, for example, be used with a component having an input face or layer comprising a concave portion. This may help to generate an input shockwave having a curved shock-front in the focusing portion.

In some embodiments, the impacting surface of the projectile comprises a curved (e.g. concave or convex) portion. Such projectiles may be used with a component having an input face or layer comprising a substantially flat portion. This may help to generate an input shockwave having a curved shock-front in the focusing portion.

Preferably the projectile comprises (e.g. is formed from, e.g. consists of) a solid. Preferably the projectile comprises (e.g. is formed from, e.g. consists of) a high shock-impedance material. In embodiments the projectile comprises (e.g. is formed from, e.g. consists of) a (e.g. heavy) metal, e.g. a transition metal, e.g. a refractory metal, e.g. tantalum. The projectile may comprise (e.g. be formed from, e.g. consists of) tungsten, steel, copper or other (e.g. heavy) metals. Thus, the projectile may be formed from the same material as the first material, the body and/or the impedance matching layer of the component.

In embodiments the projectile comprises (e.g. is formed from, e.g. consists of) the second material. Thus, in embodiments the projectile comprises (e.g. is formed from, e.g. consists of) a lower shock-impedance material, e.g. a low density metal, e.g. aluminium, or a lower density material, e.g. PMMA.

In some embodiments, the mechanism for generating a shockwave comprises an explosively driven mechanism, such as a gas gun, configured to drive the projectile into the component.

In some embodiments, the mechanism for generating a shockwave comprises an electromagnetic mechanism, such as a pulsed power machine magnetically driven plate flyer, configured to drive the projectile into the component.

In some embodiments, the (e.g. electromagnetic) mechanism for generating a shockwave comprises a direct drive mechanism configured to generate a Lorentz force in an electrode adjacent the component. In such embodiments, the Lorentz force generates a shockwave in the electrode which is transmitted to the input of the focusing portion.

In some embodiments, the mechanism for generating a shockwave comprises a laser drive mechanism. The mechanism may comprise an ablator layer adjacent the input of the focusing portion and one or more lasers configured to ablate the ablator layer creating a shockwave in the (focusing portion of the) component. In embodiments, the lasers are incident directly on the ablator layer. In embodiments, the lasers are incident on a hohlraum surface, creating X-rays that bathe the ablator material causing it to ablate.

It will be understood that the input shockwave may be formed outside of the volume, and propagate into the input of the volume, but may additionally or alternatively be generated in the component, for example by the component being struck (e.g. by a projectile). Both of these examples are covered by the wording “input shockwave”.

It will be understood that where used herein, the term “shock-impedance” is intended to mean “‘the pressure which must be applied to a medium in order to impart a unit particle velocity to some of the medium” (Henderson, ‘On the refraction of shock waves’, Journal of Fluid Mechanics, Volume 198, January 1989, pages 365-386). This is equal to the product of the shock speed and the density of the un-shocked material.

The component may have any suitable and desired dimensions, e.g. to be determined by the specific application of the component. In one embodiment the component has a thickness, diameter and/or maximum dimension between 0.1 mm and 100 mm, e.g. between 1 mm and 50 mm, e.g. between 2 mm and 10 mm, e.g. approximately 3 mm, 5 mm or 8 mm.

### BRIEF DESCRIPTION OF DRAWINGS

Certain embodiments of the invention will now be described, by way of example only, with reference to the accompanying drawings, in which:

FIG. 1 shows a component in accordance with some embodiments of the invention;

FIG. 2 shows a system incorporating the component of FIG. 1;

FIG. 3 shows a component in accordance with some embodiments of the invention;

FIG. 4 shows a system incorporating a component in accordance with some embodiments of the invention;

FIG. 5 shows an exploded view of a component in accordance with some embodiments of the invention;

FIG. 6 shows the component of FIG. 5 assembled; and

FIG. 7 shows a variant of the component of FIG. 5.

### DETAILED DESCRIPTION

Components and systems for compressing matter (e.g. fuel) by producing high localised concentrations of energy by manipulating an input shockwave to produce a high pressure quasi-spherical shockwave incident on the matter will now be described.

It will be understood that where used herein, the terms “top”, “bottom”, “up”, “down”, “side”, “base”, etc., are included for clarity and are intended to refer to the orientation shown in the enclosed Figures. It will be appreciated that, in use, the components and systems may operate in any suitable and desired orientation.

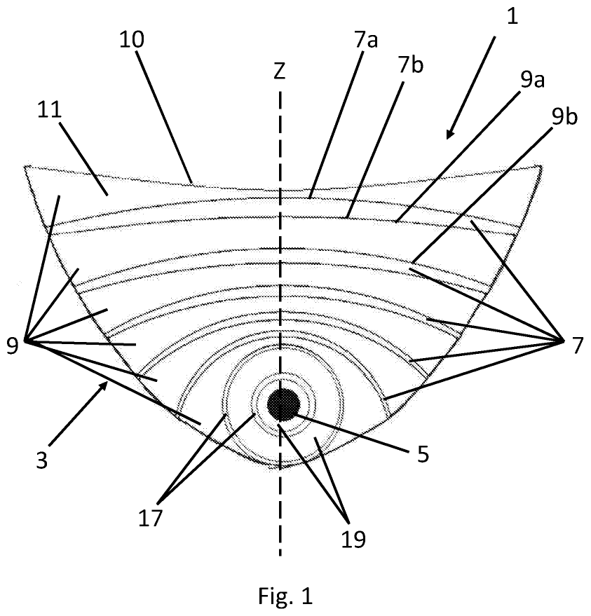

FIG. 1 shows a cross-section through a component 1 in accordance with an embodiment of the invention.

The illustrated cross section is taken in a plane containing a central longitudinal axis Z of the component 1. In the illustrated embodiment, the component 1 is rotationally symmetrical about the central axis Z. It will be appreciated that, in other embodiments, the component 1 may be cylindrically symmetrical, with FIG. 1 showing a cross-section in a plane perpendicular to the cylindrical axis of the component.

The component 1 comprises two portions, a focusing portion 3 and a target volume 5. The target volume 5 may simply be formed as a volume (e.g. cavity) in the final low shock-impedance layer. In embodiments, a discrete target chamber may be provided which is arranged to contain the matter to be compressed. The chamber may be formed of any suitable and desired material, for example, the chamber may be defined by a layer of high shock-impedance material forming a shell.

In embodiments in which the component is used in nuclear fusion applications, the matter to be compressed may be a fusionable fuel, e.g. a gaseous fusionable fuel, e.g. deuterium gas.

The target volume 5 is completely enclosed by the focusing portion 3. The focusing portion 3 comprises a plurality of layers that includes a plurality of curved layers, and a plurality of enclosing layers.

The plurality of curved layers extend across the focusing portion 3 and comprise a plurality of first curved layers that are high shock-impedance curved layers 7, and a plurality of second curved layers that are low shock-impedance curved layers 9.

The plurality of enclosing layers completely surround the target volume 5 and comprise a plurality of first enclosing layers that are high shock-impedance enclosing layers 17, and a plurality of second enclosing layers that are low shock-impedance enclosing layers 19.

The high (curved and enclosing) shock-impedance layers 7, 17 are formed from a high shock-impedance material such as tantalum, platinum, tungsten, steel, copper, or other (e.g. heavy) metals. The (curved and enclosing) low shock-impedance layers 9, 19 are formed from a low shock-impedance material such as PMMA, epoxy resin, or low density foams. The high shock-impedance layers 7, 17 are formed of a material having a higher shock-impedance than the material forming the low shock-impedance layers 9, 19.

The ratio of the shock-impedance of the high shock-impedance layers 7, 17 to the shock-impedance of the low shock-impedance layers 9, 19 is preferably large, such that there is a large shock-impedance difference at the boundaries between layers. The configuration of the layers is discussed below.

The (e.g. focusing portion of the) component comprises an input 10. The input 10 is formed by a low shock-impedance layer and, in the embodiment of FIG. 1, is concave, such that the centre of the input 10 is recessed with respect to the perimeter of the input 10.

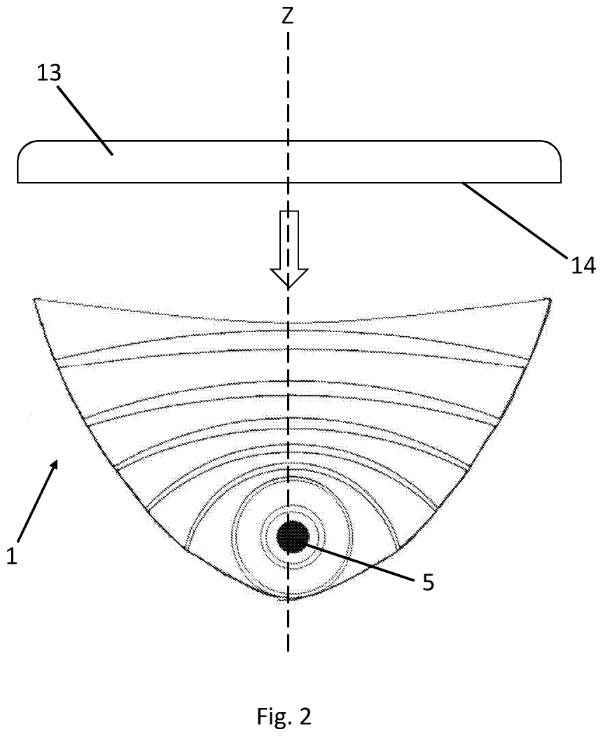

Operation of the component 1, as well as the configuration of the layers within the focusing portion 3, will now be explained with reference to FIG. 2. FIG. 2 shows a system in accordance with an embodiment of the invention, incorporating the component of FIG. 1.

The input 10 is configured to receive a shockwave. In the embodiment shown in FIG. 2, this shockwave is generated by striking the input 10 of the component 1 with a disc shaped projectile 13 having a flat impacting surface 14. In the illustrated embodiment, the projectile 13 is at least partially formed of tantalum, but may be formed of other heavy metals such as tungsten, platinum, steel or copper.

Since the input 10 is concave, the projectile 13 strikes the perimeter of the input 10 before it strikes the centre. (It will be understood that the energy and/or material of the projectile 13 and/or the material of the input 10 is such that the projectile 13 and/or the input 10 deforms, such that the projectile 13 impacts on and contacts the centre of the input 10, as it continues to travel towards and into the component 1.) This acts to give the resultant shock in the component 1 a curved front, owing to the differences in shock and particle velocities in the different stages of the process.

The projectile 13 is travelling at speed “X”, and drives a shock in the component 1 at each position it impacts with a shock velocity of “Y”. Y is greater than X, and as such, owing to the curvature of the input 10, the shock is travelling faster at the edge of the component than the projectile 13 is travelling on the central axis, and thus will be further into the component 1 by the time of the projectile impacting onto the centre of the input 10. This gives the shock a degree of spherical focusing.

The shockwave in the component 1 is then further spherically focused by the configuration of the layers 7, 9, 17, 19, with the shockwave converging at the location of the target volume 5. This creates a localised concentration of energy at the target volume 5. In nuclear fusion applications, this energy may be sufficient to collapse fusionable fuel contained in the target volume 5. This may generate conditions necessary for nuclear fusion.

The layers alternate from low shock-impedance layers 9, 19 to high shock-impedance layers 7, 17, from one layer to the next. In the illustrated embodiment, an input layer 11 which forms the input 10 of the component 1 is a low shock-impedance layer 9. This is because an input 10 formed from a high shock-impedance layer 7 may result in a larger portion of the shockwave being reflected by the input 10, and hence not transmitted into the component 1. The alternative is however envisaged, and an input 10 formed from a high shock-impedance layer 7 may help to better couple the shock into the component 1, since a high shock-impedance layer may have a more similar shock-impedance to that of the projectile 13 striking the component.

In the illustrated embodiment, the low shock-impedance layers 9, 19 have maximum thicknesses that decrease progressively from the input 10 to the target volume 5. The maximum thicknesses of the high shock-impedance layers 7, 17 also decrease progressively from the input 10 to the target volume 5.

As discussed above, the plurality of layers which make up the focusing portion comprise curved layers, and enclosing layers. Each of the high shock-impedance curved layers 7 have a convex input face 7a and a concave output face 7b. As such, with the exception of the input layer 11, each of the low shock-impedance curved layers 9 also has a convex input face 9a and a concave output face 9b.

Each of the enclosing layers (both high shock-impedance enclosing layers 17 and low shock-impedance enclosing layers 19) totally surrounds (encloses) the target volume 5. As such, the enclosing layers may be referred to as shells. In the embodiment of FIG. 1, each of the enclosing layers, and the target volume 5, are spherical. Further, each of the enclosing layers, and the target volume, are concentric. It will be understood that the enclosing layers may have any suitable shape. Further, the target volume 5 may have any suitable (e.g. non-spherical) shape. For example, the target volume 5 may be ovoidal.

The layers are arranged such that shockwaves generated at the input 10 of the component 1 reverberate within the layers, as a result of reflections from the boundaries between low and high shock-impedance layers 9, 19, 7, 17 leading to portions of constructive and destructive interference as shock waves pass over one another. When a shock passes from a low shock-impedance layer 9, 19 into a high shock-impedance layer 7, 17 a portion of the shock is transmitted into the high shock-impedance layer 7, 17 whilst a portion is reflected back into the low shock-impedance layer 9, 19.

The portion in the low shock-impedance layer 9, 19 speeds up since it is now travelling through pre-shocked material. The shock portion then reflects from the boundary at the input of the low shock-impedance layer, and since it has been sped up, the reflected portion eventually catches up with the portion of the shock that was initially transmitted into the high shock-impedance layer 7.

Through the arrangement of the low and high shock-impedance layers, the component 1 can be arranged such that a plurality of shock portions superimpose at the target volume 5, leading to a short-lived high shock pressure state that (in nuclear fusion applications) may be sufficient to collapse fusionable fuel contained within the target volume 5.

In the illustrated embodiment, all of the high shock-impedance layers 7, 17 are formed from the same material, and all of the low shock-impedance layers 9, 19 are formed from the same material. In embodiments, different low shock-impedance materials may be used for the different low shock-impedance layers 9, 19 and different high shock-impedance materials may be used for the different high shock-impedance layers 7, 17.

The high shock-impedance curved layers 7 each have a variable thickness such that they are thicker on the longitudinal axis Z than at their edges. Similarly to the function of the concave input face described above, this acts to curve the shock because the shock speed in the high shock-impedance layers is slower than in the low shock-impedance layers. Therefore, since the portion of the shock-front on the longitudinal axis Z has to travel through more high shock-impedance material than the portion of the shock-front at the edge, the portion of the shock-front at the edge overtakes the central portion of the shock-front, resulting in spherical focusing.

The high shock-impedance layers 9 are curved because the shockwave becomes increasingly spherical as it propagates through the component 1. As such, for the shocks to effectively reflect from the boundaries between the layers, the boundaries between the layers are similarly curved, such that the boundary at any given position is approximately parallel to the shock-front at that position.

Similarly, for the shocks to effectively propagate from the output (without at least partially undoing the spherical focusing) the output face is curved in line with the curvature of the layers, such that the output face at any given position is approximately parallel to the shock-front at that position. It can be seen clearly from FIG. 1 that the radii of curvature of the input faces and output faces of the curved layers decreases progressively from the input 10 to the target volume 5.

In preferred embodiments, the curve on the input face 7a of each high shock-impedance curved layer is not more than the curvature of the output face 7b of the previous high shock-impedance curved layer 7. If this is not the case, the distance between the two high shock-impedance layers will be greater at the edges of the layers than on the central axis. Therefore, the reverberations will take longer at the edges and hence the shock front at the central axis will ‘catch up’, reducing the degree of spherical focusing.

Once the shockwaves have reached the enclosing layers 17, 19, the shockwaves have been spherically focused such that the shock-front is now approximately spherical. The enclosing layers 17, 19 work in the same way as the curved layers, relying on the reverberations which result from reflections at the boundaries between layers. Additionally, the spherical shape of the enclosing layers acts to enhance the spherical focusing of the shockwaves such that the shock-state which is generated at the target volume 5 acts to compress the matter to be compressed from all directions.

Through configuration of the layer materials, shapes and thicknesses, it is possible to control the pressure of the shock at the target volume 5, as well as the uniformity of the shock state and shape.

In addition to generating the conditions for local shock superposition and constructive interference, the layers 7, 9, 17, 19 also act to effectively slow the shock transit time through the component 1. This allows energy from more of the projectile 13 to be harvested and combined into a single shock state at the target volume 5.

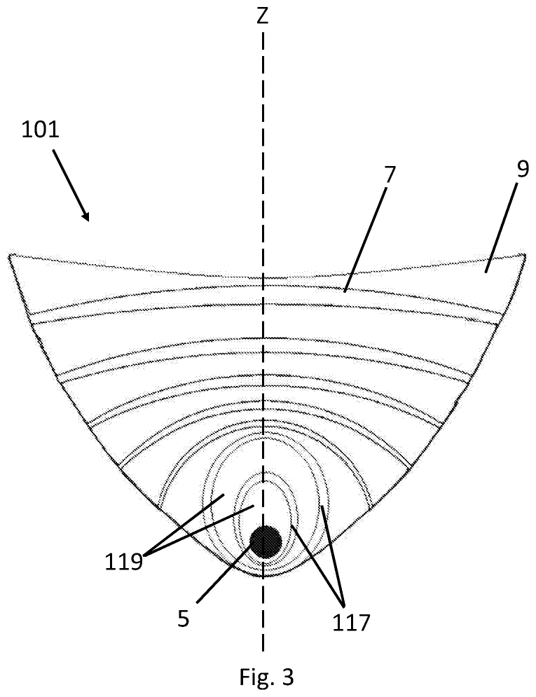

FIG. 3 illustrates a cross sectional view through a component 101 which is a variant of the component 1 of FIG. 1. The curved layers 7, 9, of the component 101 are the same as the curved layers 7, 9 of the component 1 shown in FIGS. 1 and 2, but the enclosing layers (high shock-impedance enclosing layers 117, and low shock impedance 119) of the component 101 are ovoidal (egg shaped).

Further, each of the enclosing layers 117, 119, and the target volume 5, are not concentric. Rather, moving from the input 10 towards the target volume 5, the centre of each enclosing layer is further from the input 10 than the centre of the previous enclosing layer. The result of this is that the enclosing layers are thickest at the longitudinal axis Z. This acts to further spherically focus the shock because the portion of the shock-front which is propagating along the longitudinal axis has more material to travel through before reaching the target volume 5. This gives the portions of the shock-front to the side of, and below, the target volume 5 chance to catch-up and wrap around such that the entire shock front reaches the target volume 5 together.

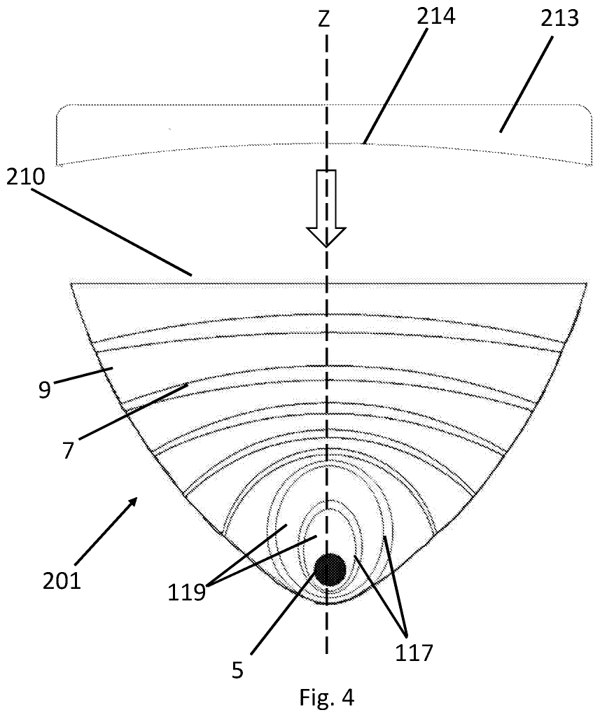

FIG. 4 shows a system comprising a component 201 which is a variant of the component 101 shown in FIG. 3. The component 201 is the same as the component 101, with the exception of the fact that the component 201 has a flat input face 210. As such, the component 201 is configured to be used with a projectile 213 having a concave impacting surface 214.

Such a projectile 213 is shown in FIG. 4. Striking a flat component input face 210 with a concave projectile impacting surface 214 has a similar effect to striking a concave input 10 with a flat projectile impacting surface 14. In the illustrated embodiment, the projectile 213 is at least partially formed of tantalum, but may be formed of other heavy metals such as tungsten, platinum, steel or copper.

Since the impacting surface 214 is concave, the projectile 213 strikes the perimeter of the input face 210 before it strikes the centre. This acts to give the resultant shock in the component 201 a curved front due to the differences in shock and particle velocities in the different stages of the process. The projectile 213 is travelling at speed X, and drives a shock in the component 201 at each position it impacts with a shock velocity of Y. Y is greater than X, and as such, owing to the curvature of the projectile impacting surface 214, the shock is travelling faster at the edge of the component 201 than the projectile 213 is travelling on the longitudinal axis Z, and thus will be further into the component 201 by the time of projectile impact on the central axis. This gives the shock a degree of spherical focusing.

It may be preferable to provide the curve on the projectile impacting face 214, rather than on the component input face 210. This is because, if the projectile 13 is flat on impact and the component input face is concave (as shown, for example, in FIG. 2), a curved shock will be created (as the shock speed is higher than the projectile velocity), but the projectile interface will curve the other way, filling the space formed by the concave input face (as the particle velocity is less than the projectile velocity). By contrast, providing the concave face on the projectile 213 rather than on the component input face 210 (e.g. as shown in FIG. 4), will leave a projectile impacting surface 214 that is still concave after impact, which may be preferable for subsequent reverberations.

Although only the component 201 having ovoidal enclosing layers 117, 119 is shown with a flat input face 210, it will be understood that the component 1 with spherical enclosing layers may also be provided with a flat input face, and configured for use with a projectile 213 having a concave impacting surface 214.

Although such embodiments are envisaged, it may not be preferable to have a concave surface on both the projectile and the component input surface, since this may result in the formation of a jet which propagates from the initial impact point on the perimeter towards the central axis which compromises the shock shape.

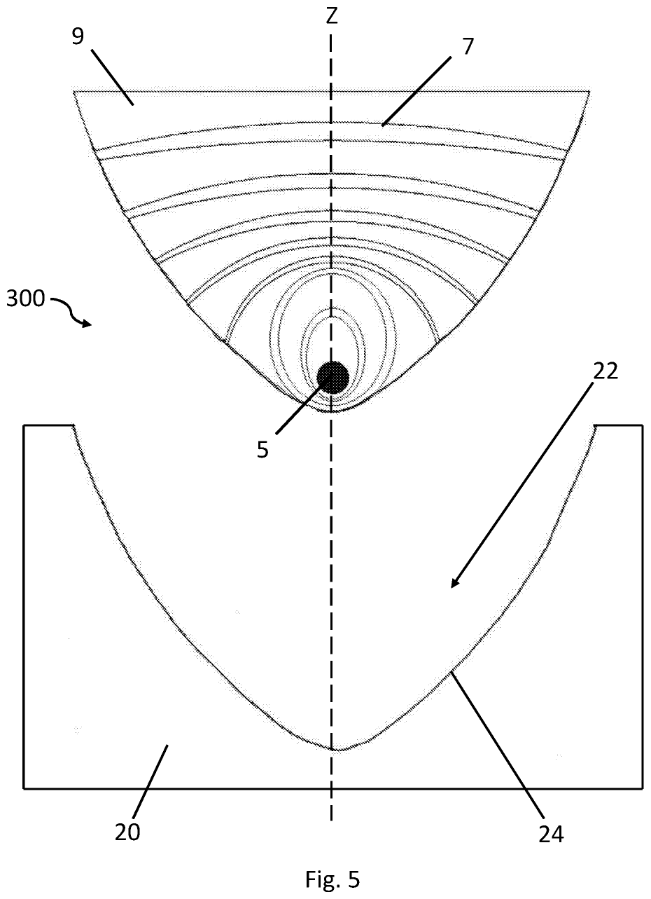

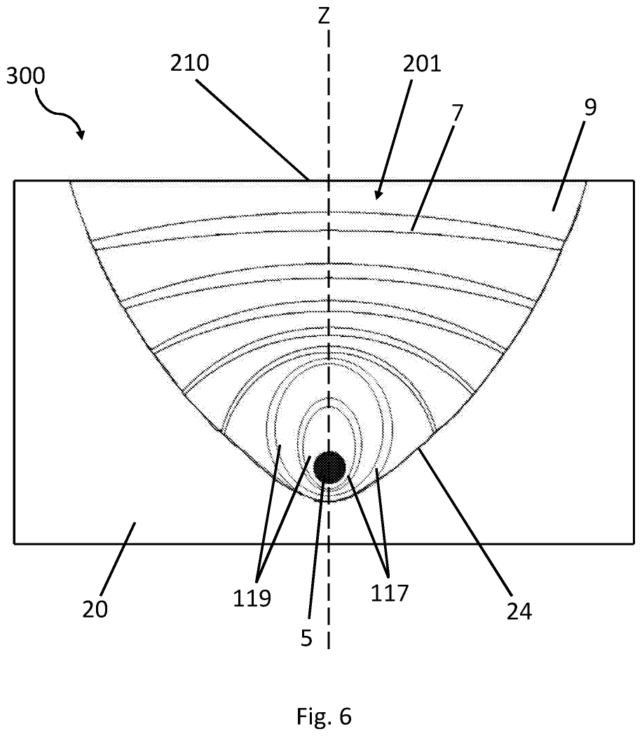

FIG. 5 shows an exploded view of a cross section through a component 300 in accordance with one embodiment of the invention. In addition to the layered structure of component 201, the component 300 comprises a body 20 that defines a hollow bowl-shaped recess 22. The recess 22 is defined by recess walls 24, the angle of which varies continuously (e.g. is curved) such that the recess is bowl-shaped. The body 20 is formed of a material having a high shock-impedance. In an exemplary embodiment, the body 20 is formed of tantalum. The body 20 may be formed of other materials, for example other heavy metals, e.g. tungsten, steel, copper or platinum. The component 300 assembled is shown in FIG. 6.

In the illustrated embodiment, the high shock-impedance layers 7, 17, and the body 20 are formed from the same material. As such, the high shock-impedance curved layers 7 which are incident with the recess walls 24 may be unitarily formed with the body 20.

By combining the arrangement of layers with a body 20 defining a recess 22 in which the layers are housed, elements of the shockwave which may otherwise have been lost from the sides of the layers are reflected back into the layers by the boundary between the low-shock impedance material of the low shock-impedance layers 9, and the high shock-impedance recess walls 24. This may result in a more intense eventual shock state at the target volume 5.

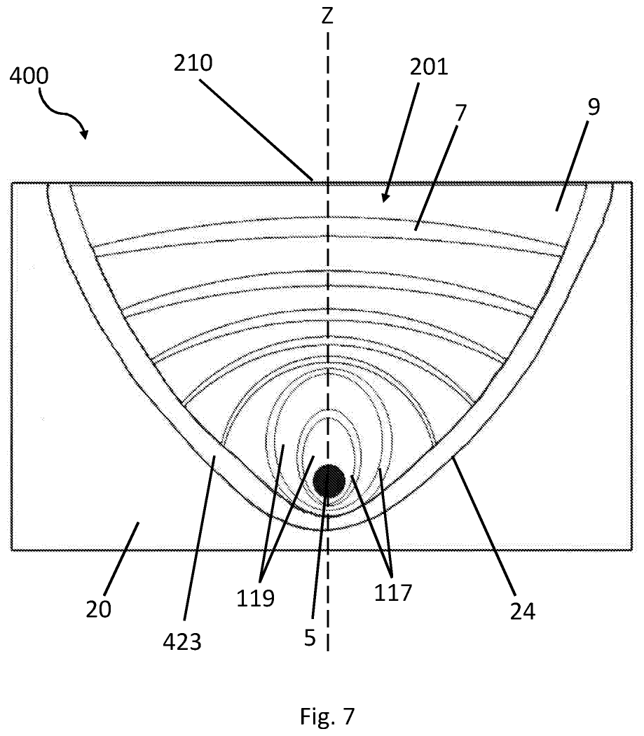

FIG. 7 shows a variant of the embodiment of FIGS. 5 and 6. The component 400 comprises a buffer 423 between the edges of the component 201, and the recess wall 24. The buffer 423 is formed of a low density material such as PMMA or epoxy resin, and may be formed of the same material as the low shock-impedance layers 9, 19. The buffer 423 may help to reflect the shocks from the recess wall 24.

It will of course be understood that any of the components discussed herein can be combined with a body having a suitably shaped recess. It will further be understood that the recess may not be bowl shaped, and may instead be straight walled, or have walls that have a plurality straight sections which make different angles with the longitudinal axis Z.

Although specific examples have been given, it will be appreciated that there are a large number of parameters that may influence the actual results achieved.

In the embodiments described above, the diagrams shown are a vertical cross-section through a three-dimensional component and hence they depict embodiments that are rotationally symmetric. However, this is not essential to the invention.

It will be understood that the embodiments explicitly disclosed herein are intended to be exemplary, and the skilled person will understand that features of the embodiments disclosed herein may, except where mutually exclusive, be combined in combinations not explicitly mentioned in order to form new embodiments.

Although the input faces of the components shown in the illustrated embodiments are planar or concave, it will be appreciated that embodiments exist in which the input face is at least partially convex. Similarly, although the projectiles shown in the illustrated embodiments have impact faces that are planar or concave, it will be appreciated that embodiments exist in which the (e.g. impact face of the) projectile is at least partially convex.

Embodiments of the invention may be suitable for amplifying shockwaves for the purpose of generating conditions suitable for nuclear fusion; however, the invention is not limited to this, and may be used for other applications.

1. A component for compressing matter using an input shockwave, the component comprising:
a volume defined within the component, wherein the volume is configured to contain the matter to be compressed; and
a focusing portion configured to manipulate the input shockwave to generate a localised concentration of energy at the volume;
wherein the focusing portion comprises:
an input for inputting the input shockwave into the component; and
a plurality of layers;
wherein the plurality of layers comprises:
one or more first layers comprising a first material; and
one or more second layers comprising a second material that is different from the first material; and
wherein one or more layers of the plurality of layers comprises an enclosing layer that surrounds the volume.

2. The component as claimed in claim 1, wherein the second material has a shock-impedance that is lower than a shock-impedance of the first material.

3. The component as claimed in claim 1, wherein each layer of the plurality of layers comprises an input face and an output face; and
wherein the input face and/or the output face of one or more of the plurality of layers comprises a curved portion.

4. The component as claimed in claim 1, wherein each layer of the plurality of layers comprises an input face; and
wherein the input face of one or more layers of the plurality of layers comprises a convex portion.

5. The component as claimed in claim 4, wherein the input face of two or more of the plurality of layers comprises a convex portion; and
wherein the radius of curvature of the convex portion(s) of layer(s) distal from the volume are greater than the radius of curvature of the convex portion(s) of layer(s) proximal to the volume.

6. The component as claimed in claim 1, wherein each layer of the plurality of layers comprises an output face; and
wherein the output face of one or more layers of the plurality of layers comprises a concave portion.

7. The component as claimed in claim 6, wherein multiple layers of the plurality of layers have an output face comprising a concave portion; and
wherein the radius of curvature of the concave portion(s) of layer(s) distal from the volume are greater than the radius of curvature of the concave portion(s) of layer(s) proximal to the volume.

8. The component as claimed in claim 1, wherein one or more of the plurality of layers has a non-uniform thickness.

9. The component as claimed in claim 8, wherein the thickness of one or more layers of the plurality of layers is greater proximal to a central axis of the component than proximal to the edge of the respective layer.

10. The component as claimed in claim 1, wherein the one or more first layers and the one or more second layers are arranged to alternate between a first layer and a second layer.

11-12. (canceled)

13. The component as claimed in claim 1, wherein the volume is off-centre relative to the one or more enclosing layers.

14-15. (canceled)

16. The component as claimed in claim 1, wherein the component further comprises a body comprising a recess, and wherein the volume and focusing portion are located at least partially within the recess.

17. The component as claimed in claim 16, wherein the body comprises one or more recess walls that define the recess.

18. The component as claimed in claim 16, wherein the body comprises a third material, and wherein the third material has a higher shock-impedance than the second material.

19. The component as claimed in claim 18, wherein the third material is the same as the first material.

20. The component as claimed in claim 16, wherein the component further comprises a buffer between the focusing portion and the body.

21. A method of compressing matter using an input shockwave, the method comprising generating the input shockwave at the input of the focusing portion of the component according to claim 1.

22. A system for compressing matter using an input shockwave, the system comprising:
a component as claimed in claim 1; and
a mechanism for generating the input shockwave at the input of the focusing portion of the component.

23. The system as claimed in claim 22, wherein the mechanism comprises a driving mechanism configured to drive a projectile into the component to generate a shockwave at the input of the focusing portion of the component.

24. (canceled)

25. The component as claimed in claim 1, wherein the matter to be compressed comprises a fuel.
